(19) United States
(12) Patent Application Publication
(10) Pub. No.: US 2020/0331290 A1
(43) Pub. Date: Oct. 22, 2020

(54) MECHANICAL AUXILIARY TRACTION SYSTEM

(71) Applicants: Ricardo Achcar, (US); Claudia Veronica Achcar, (US); Anis Roger Achcar, Rio de Janeiro (BR)

(72) Inventor: Ricardo Achcar, Coral Spring, FL (US)

(73) Assignees: Ricardo Achcar, Coral Springs, FL (US); Anis Roger Achcar, Rio de Janeiro (BR); Claudia Veronica Achcar, Coral Springs, FL (US)

(21) Appl. No.: 16/850,112

(22) Filed: Apr. 16, 2020

Related U.S. Application Data
(60) Provisional application No. 62/834,521, filed on Apr. 16, 2019.

(51) Int. Cl. B60B 15/26; B60B 11/10

(52) U.S. Cl. CPC B60B 15/263; B60B 11/10

(57) ABSTRACT

An auxiliary traction system for imparting auxiliary traction to a vehicle, the system including: a first traction assembly including a first tire and a wheel, the wheel is placed inside the first tire; a second traction assembly including a second tire; a second wheel having a first end connected to the wheel of the first traction assembly and a second end passing through the second tire; the first end of the second wheel has a first flange having a convex shape that fits into a central hole of the wheel; and the second end of the second wheel has a second flange having a concave shape.

### CROSS REFERENCE TO RELATED APPLICATION

This application claims the benefit of priority to U.S. Provisional Application No. 62/834,521, filed Apr. 16, 2019, the contents of which are incorporated herein by reference.

### FIELD OF THE INVENTION

The present invention relates to a system that increases vehicle tire traction and, more particularly, to an auxiliary traction system for use with an inner second internal tire that provides additional traction capability to the vehicle when it is stuck in mud, snow, sand, or other conditions, which otherwise limit the traction of the vehicle in normal operation.

### BACKGROUND OF THE INVENTION

Increasingly, the automotive industry is in demand for new vehicles that perform better according to the buyer's profile, his/her displacement needs, and irregular road systems. These vehicles include high-performance sports cars, high-end luxury cars, mixed vehicles for city and road/field, military vehicles, and utility vehicles.

Except for those vehicles which are specifically designed for special types of terrains, most of the common tires are intended for use on smooth, hard-surfaced roads. In view of this, the conventional tire is not provided with a device that provides proper traction in a soft surface condition, such as sand, mud, or gravel surfaces that are commonly found in off-road situations; thus, the vehicle would be unable to move when such surface conditions exist.

The prior art shows various types of systems for vehicles in order to increase the traction (contact of the vehicle with the ground) of the vehicles. One of the most popular systems uses tire chains.

Unfortunately, tire chains are difficult to install, they break while driving at high speeds, and damage the tire and the road if they are driven on dry, hard road surfaces.

In view of the above, there is a need to provide an easy to install auxiliary traction system that is secured to the wheel of the vehicle to provide increased traction as needed.

### SUMMARY OF THE INVENTION

It is an objective of the presented invention to provide a traction system that allows a vehicle to request traction in severely irregular ground conditions, without requiring additional assembly or fittings in locomotive systems and at a significantly lower cost.

The system of the present invention outclasses and excels by the simplicity of the solution, promoting efficiency of the vehicle in situations in need of auxiliary traction and economy, because the system only acts when requested, which avoids the unnecessary consumption of fuel and the wear of the engine, by increasing the traction in floors in which extra effort is not necessary.

An auxiliary traction system for imparting auxiliary traction to a vehicle, the system including: a first traction assembly including a first tire and a wheel, the wheel is placed inside the first tire; a second traction assembly including a second tire; a second wheel having a first end connected to the wheel of the first traction assembly and a second end passing through the second tire; the first end of the second wheel has a first flange having a convex shape that fits into a central hole of the wheel; and the second end of the second wheel has a second flange having a concave shape.

### BRIEF DESCRIPTION OF THE FIGURES

FIG. 1 shows a mathematical formula showing the principle of the present invention;

FIG. 2 shows a perspective view of the auxiliary traction system according to an embodiment of the present invention;

FIG. 3 shows a side view of the system of FIG. 2;

FIG. 4 shows an exploded view of the system of FIG. 2;

FIG. 5 shows a cross sectional view of the system of the present invention; and

FIG. 6 shows the system of FIG. 2 installed in a vehicle showing only the axle of the vehicle and its suspension.

### DETAILED DESCRIPTION OF THE INVENTION

Although described in its preferred embodiment, the present invention may also be performed by means of variations and adaptations not shown, but also intended and included in the scope presently claimed.

The present invention provides an improved auxiliary tire traction device for use with the wheels of vehicles to provide increased traction, on demand, wherein the system is economical to manufacture, durable in use, easy to use and adaptable for use with substantially any vehicle wheel or tire, which is economical in use, which may be readily maintained and repaired during use of the device and which may be modified for use in conjunction with any particular configuration.

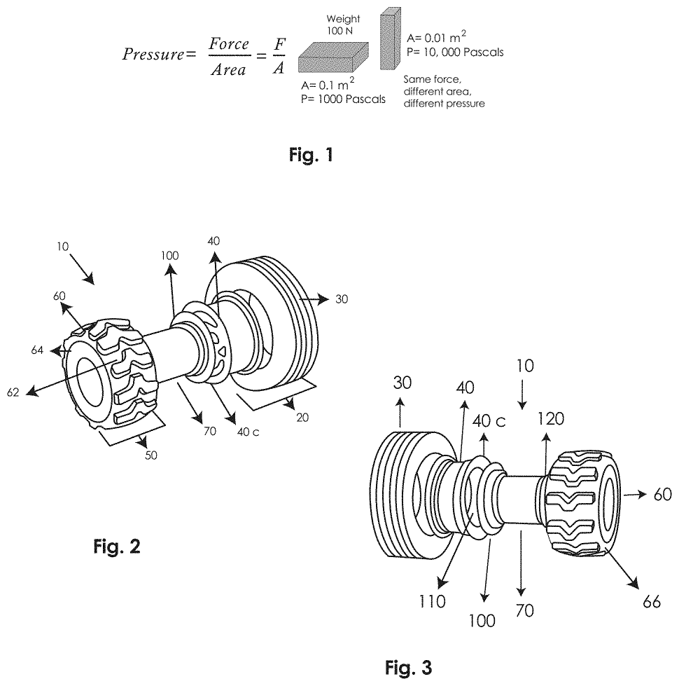

FIG. 1 shows the mathematical formula showing the principle of the present invention. Pressure is defined as force per unit area. The standard unit for pressure is the Pascal, which is a Newton per square meter.

The formula of FIG. 1 is entirely related to the force of gravity.

A tire suitable for traveling legally according to international traffic laws, to run on a 16-inch wheel, usually has an approximate preferred width of 6 inches. Suppose that in a normal rear engine traction of a four-wheel vehicle, in one of the rear corners of a vehicle, the tire will support a fixed physical load corresponding to 400 pounds. This weight will be distributed over the corresponding tire contact area that is called the patch.

In the case of our example, multiplying 6″×4″ equals 24 square inches=patch. If we divide 400 pounds by 24 inches, it can be found a nominal weight/load per square inch corresponding to 16.66 pounds of weight concentrated on each square inch directed towards the center of the planet. This weight is in reality the force of gravity towards the center of planet Earth.

In the present case, the described wheel will perform running, rolling, and providing traction on the asphalt of the roads. The moment this wheel enters muddy terrain, it will gradually sink to the point of no longer exercising its TRACTION function because the load exerted on the muddy floor ceases adherence, resulting in SKIDDING and consequently, loss of traction.

About 4 inches separate the tire from its point of traction on the asphalt to the wheel rim where it is mounted. At this point of sinking, skidding, and loss of traction in the soft terrain or mud, the second extra wide and low pressure tire, according to the present invention, reduces the total vehicle corner weight, for example, 400 pounds per square inch concentrated on the ground to 6.25 pounds per square inch, in this case, not metaphorically expressing, can roll over your feet without causing damage.

How does that happen? It happens because we now have a patch of 24″ added to a patch of 40″, totaling 64″ of patch in contact with the ground. If you divide 400 pounds by 64, you will get 6.25 psi of concentrated weight in each pound, instead of 16.66 psi. The vehicle becomes almost a Lunar operating vehicle, according to loss of gravity, compared to earth that is 6 times less because of weight distribution in a larger support area.

That's what the formula of FIG. 1 demonstrates.

The vehicle with the system, according to the present invention, may travel legally in any country and conventional roads in the world and on any type of terrain.

In addition, the system according to the present invention provides an easy exchange of the external tire, meanwhile, the internal tire will be almost impossible to puncture or destroy for some technical reasons, such as having 6-plies (extremely strong military-grade) and a very low pressure 12″ psi. A standard car usually uses 30 psi, which accommodates almost any kind of pointed or perforating object, such as a pointed stone or other.

Any modern SUV mounted on 4 wheel traction and where the front engine cannot come close to the terrain, our automobile utility vehicle is able to go for one major simple reason: The front engine represents the greater obstacle of a weight aiming at the center of the planet. As soon as the front tires descend about 6″+ inches, the vehicle will lose 70% of its speed and start to gradually sink in a matter of x yards. If the vehicle is a front engine with rear traction, it will sink sooner.

After a long time of search and research, the present inventor discovered that the system of the present invention does not perform well on conventional front engine vehicles. It is a need for physical operation for the traction system according to the present invention where the vehicle's engine (power) is placed on the rear axle of the vehicle. Thus, the system according to the present invention is preferably used on extra lightweight vehicles. The vehicle may preferably be a rear traction and rear engine vehicle, for example, a standard passenger vehicle or a VW Bug vehicle. SUVs are not considered light weight vehicles.

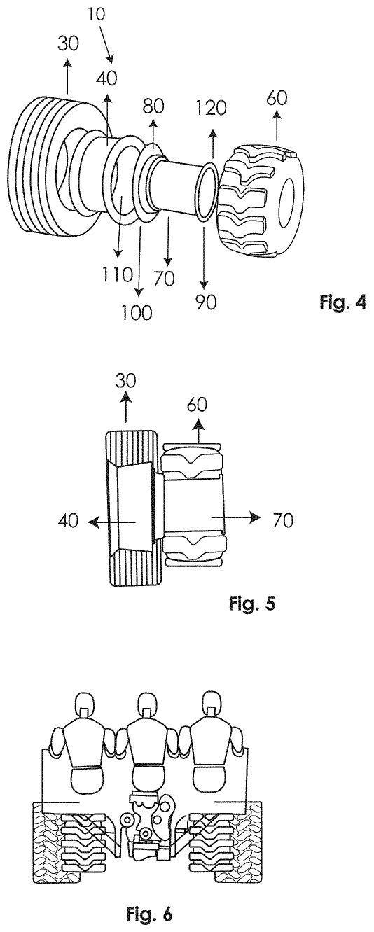

FIGS. 2-5 show the auxiliary traction system 10 according to the present invention. The auxiliary traction system 10 may be employed in combination with any type of rear traction and rear engine vehicles.

The auxiliary traction system 10 imparts auxiliary traction to a rear traction and rear engine vehicle and includes:

a first traction assembly 20 including a first tire 30 and a first wheel 40, the first wheel 40 is placed inside the first tire 30;

a second traction assembly 50 including a second tire 60 and a second wheel 70, the second wheel having a first end 80 connected to the first wheel 40 of the first traction assembly 20 and a second end 90 passing through and fixed to the second tire 60;

wherein the first end 80 of the second wheel 70 has a first flange 100 having a convex shape that fits into a rim 40c of the first wheel 40; and

wherein the second end 90 of the second wheel 70 has a second flange 120 having a concave shape.

The first tire 30 may be any commercially available tire. The first tire 30 is a standard tire normally available with the vehicle.

The second tire 60 is wider than a normal tire and includes deep voids 62, angled central lugs 64, and sidewall lugs 66.

The deep voids 62 help the tire clear mud, gravel, and debris as it spins, ensuring that there will be a fresh surface to grip.

The angled central lugs 64 help to claw through and grab onto challenging off-road terrain surface, and effectively develop grip where less standard tires cannot.

The sidewall lugs 66 contribute additional biting edges to laterally grab onto the terrain.

The second tire 60 may be any commercially available mud tire for ATV or UTV drive, for example, a mud rebel tire by Sedona, a 12″ SEDONA tire (570-4012/22x8-10).

The second tire 60 has a diameter smaller than a diameter of the first tire 30. Through a lot of search and research, the present inventor discovered that in order for the auxiliary system to work properly, the radius of the second tire 60 needs to be 4 inches smaller than a radius of the first tire.

Because the second tire is smaller than the first tire, in normal conditions, only the first tire 30 contacts the surface and the second tire 60 contacts the surface when additional traction is required. At this time, the effective load on the first tire 30 shares the weight of the vehicle with the second tire 60; thus, the traction is modified and is more suitable to adhere to the terrain.

The second wheel 70 interconnects with to a rim 40c of the first wheel 40, keeping the first and second tires at a desirable distance to cope with tire expansion and flexion.

The second wheel 70 is an elongated one-piece cylindrical tube measuring between 10 to 12 inches long to be able to fit into the second tire that has no more than 10 to 12 inches width, for example a Sedona tire (570-4012/22x8-10).

The first end 80 of the second wheel 70 has a first flange 100 having a convex shape that fits into the rim 40c of the first wheel 40. The first end 80 of the second wheel 70 is connected to the rim 40c of the first wheel 40 by using, for example, bolts.

The size of the flange 100 may depend on the size of the rim 40c of the first wheel 40.

The second end 90 of the second wheel 70 has a second flange 120 (right side tire border retainer) having a concave shape. The second flange 120 is secure to the second tire 60 by any conventional method.

The second wheel 70 may be made of a strong material, for example, automotive grade steel, aluminum, or polymers.

The pairing wheels are bolted and for so can be separated if necessary but tire repair may not imply desassembling the combined tire set. Two inches of separation between tire carcasses free up enough space for tire repair or exchange.

In one embodiment, the second wheel 70 is generally already mounted on the second tire 60 when the latter is connected to the wheel 40 of the first tire 30.

During operation, the second tire 60 rotates at a predefined speed of the first tire 30 of the vehicle, due to their connection by the second wheel 70.

The multiplicity of tires and rims available on the market provide a device which operates by two wheels and distinctive diameter features.

In one embodiment, the system according to the present invention will carry an inner disk brake close to the gearbox/transmission freeing up completely the hydraulic oil pipe from being extended close to the wheel as usual in the auto industry.

The suspension system, however, is a fully proprietary design that does not take into play or patent because it is unsuitable for anything other than our MECHANICAL SYSTEM OF AUXILIARY TRACTION.

The axle has a shaft/hub of great depth in the direction of the central axis of the vehicle, so as to allow the wide inner arc to rotate in tandem with the suspension triangles and there is room for the damping spring assembly connected at the lower inner tip of the vehicle. The shaft operates normally while connected to the chassis of the vehicle.

In FIG. 6 is shown the auxiliary traction system applied to the axle/suspension of a vehicle.

The proposed invention is aiming to specifically protect the pairing of two wheels composed of tires and wheels with variation of a minimum of 4 inches of the internal tire (second tire) in relation to the external tire (first tire). Both wheels connected and running simultaneously in any position of the four or more contact corners to the ground of any vehicle seeking traction for locomotion.

The automobile industry can understand by mistake that the proposed traction system attaches only to the rear axle of a vehicle, which is not the case. The inventor's intent is primarily aimed at the traction system in its functionality no matter where it is placed on a vehicle's drive axle.

There is a major production of front wheels traction vehicles and four wheels traction vehicles and the present system will benefit traction in any position it may be placed even though the vehicle price will become very expensive. One can imagine a front traction vehicle having to cope with a directional system incorporating the proposed traction invention.

As previously stated, the present invention has been defined in terms of its preferred embodiment, however, certain modifications and alterations visible from the teachings were disclosed, but not shown, are presently comprised within the scope presently claimed, and thus understood by the present invention.

What is claimed is:

1. An auxiliary traction system for imparting auxiliary traction to a vehicle, the system is adapted to be connected to a standard traction system of a vehicle and comprises:
a first traction assembly including a first tire and a first wheel, the first wheel is placed inside the first tire, the first traction assembly is operatively connected to the standard traction system of the vehicle;
a second traction assembly including a second tire and a second wheel, the second wheel is a one-piece elongated tube having a first end connected to the first wheel of the first traction assembly and a second end housed on the second tire;
wherein the first end of the second wheel has a first flange having a convex shape that fits into a central hole of the first wheel; and
wherein the second end of the second wheel has a second flange having a concave shape.

2. The system according to claim 1, wherein the second tire has a radius that is at least 4 inches smaller than a radius of the first tire.

3. The system according to claim 1, wherein the second tire includes deep voids, angled central lugs, and sidewall lugs.

4. The system according to claim 1, wherein the second tire is a 12 psi tire.

5. The system according to claim 1, wherein the second wheel has a lenght between measuring between 10 to 12 inches.

6. A combination of a vehicle with an auxiliary traction system, the combination comprising:
a rear traction and a rear engine vehicle;
an auxiliary traction system;
wherein the auxiliary traction system includes:
a first traction assembly including a first tire and a first wheel, the first wheel is placed inside the first tire, the first traction assembly is operatively connected to the standard traction system of the vehicle;
a second traction assembly including a second tire;
a second wheel is a one-piece elongated tube having a first end connected to the first wheel of the first traction assembly and a second end housed on the second tire;
wherein the first end of the second wheel has a first flange having a convex shape that fits into a central hole of the wheel; and
wherein the second end of the second wheel has a second flange having a concave shape.

7. The combination according to claim 6, wherein the second tire has a radius that is at least 4 inches smaller than a radius of the first tire.

8. The system according to claim 6, wherein the second tire includes deep voids, angled central lugs, and sidewall lugs.

9. The combination according to claim 6, wherein the second wheel has a lenght between easuring between 10 to 12 inches.
